(19) United States
(12) Patent Application Publication
(10) Pub. No.: US 2007/0260523 A1
(43) Pub. Date: Nov. 8, 2007

(54) Systems and methods for a referral email generator and management system

(76) Inventors: James P. Schadt, Westport, CT (US); John T. Regland JR., Westport, CT (US); Paul Butcher, Southport, CT (US); Brian Gilhuly, Weston, CT (US)

Correspondence Address: ROPES & GRAY LLP;PATENT DOCKETING 39/361, 1211 AVENUE OF THE AMERICAS, NEW YORK, NY, 10036-8704, US

(21) Appl. No.: 11/711,575

(22) Filed: Feb. 26, 2007

Related U.S. Application Data
(60) Provisional application No. 60/776,390, filed on Feb. 24, 2006.

(51) Int. Cl. G06Q 30/00

(52) U.S. Cl. 705/14

(57) ABSTRACT

Systems and methods are provided for generating referral emails. Particularly, referral emails are generated as part of a campaign initiated by a member of an online community. The referral emails are customized based on both information about the potential member and the referring member. An email campaign may include a number of emails that change over time as a result of particular events being triggered. Links for particular assets, such as privileged web content, may be included in emails. Such links may be selectively chosen from an asset database. Such a selection may be chosen, for example, based on the stage of the referral/marketing campaign, information about the potential member, information about the referring member, and the contents of the assignment database.

### CROSS-REFERENCE TO RELATED APPLICATION

This application claims the benefit of U.S. Provisional Patent Application No. 60/776,390, filed Feb. 24, 2006, which is hereby incorporated by reference herein in its entirety.

### BACKGROUND OF THE INVENTION

Traditional online services use a brute force marketing methodology when attempting to attract new users. Particularly, online services traditionally purchase lists of email addresses and send a uniform marketing letter to each email address on the list. Recipients of such marketing letters rarely read these marketing letters and frequently consider the marketing letters spam.

It is therefore desirable to provide systems and methods that increase the chance that recipients of marketing letters will not only read marketing letters, but respond positively to read marketing letters.

### SUMMARY OF THE INVENTION

An online community that encourages members to refer potential members is provided. Particularly, a system is provided that allows a member to enter in the contact information of a personal friend, associate, or acquaintance that the member believes has the potential to become a member. After the information is entered to create a potential, or prospect, member profile, a referral marketing campaign may be initiated for the prospect. This marketing campaign can be initiated automatically after generation of the potential, or prospect, member profile or at some later time as a result of manual input from the member that created the potential, or prospect, member profile. Allowing a user to initiate a referral marketing campaign may be beneficial as doing so may allow the user to first contact the prospect personally (e.g., via phone or in person) before the marketing campaign is initiated. As such, manual initiation of a marketing campaign allows the person closest to the prospect in the community decide the right time to attempt to bring the prospect into the community. Manual initiation of the campaign may increase the likelihood that the prospect will enroll or participate in the campaign.

One or more marketing campaigns may be provided. The selection of a particular marketing campaign may be performed automatically, manually selected by an administer of the community, or manually selected by the referring member. To facilitate automatic campaign selection, in some embodiments, marketing campaigns may be associated with a type, or category, of prospect. For example, a prospect that is classified as a teacher, parent, coach, or industry/work peer may receive a different marketing campaign than a prospect that is classified as a friend, sibling, or student. The selected marketing campaign can be determined based on any suitable information about a potential member or the member that referred the potential member. The selected marketing campaign may also be determined based on the marketing campaigns that have not yet been initiated for a particular potential member or category. The selected marketing campaign may also be determined based on the marketing campaigns that have been the most successful or meet a particular threshold of success for a period of time. For example, campaigns may be ranked or classified based on their level of prospect participation.

A marketing campaign is provided, for example, through a series of emails, or physical letters, that are electronically, or physically, delivered to a potential member. Each email is generated and sent with an email generator to conform to the marketing campaign (e.g., a phase of the marketing campaign).

Generally, a referral email for a potential member is generated so that the email is certified by both an editor, or other authoritative figure of the community, and the member that referred the potential member. If members are provided with email addresses, the referral email may be autonomously generated and sent from this email address by a referral email generator. Alternatively, the reply-to email address, and the address shown as sending the email, for a referral email may be the community email for the referring member. Alternatively still, the referring member's personal email address may be used so that the potential member may recognize the email as coming from a friendly source even before the email is read. This may reduce the likelihood of the email being blocked by an email spam filter or any other type of email filter. An email generator may feed particular content, such as tagged content, into email templates to create a particular email. After a referral email is generated, all or particular portions of the email may be made available to the referring member such that the referring member can tailor the email. For example, a generator may generate a preferred email and provide the generated email to the referring member with an email editor so that the email may be edited. Only particular portions of the email may provided to a referring member for editing. For example, a member may be provided the opportunity to edit and personalize the introductory and concluding paragraph of the letter. Thus, in some embodiments, a member may not be allowed to tailor a body that includes a variety of tagged content (e.g., links to particular assets).

A campaign may progress, for example, through a series of periodic emails until a potential member requests that the campaign be terminated, the campaign naturally terminates, the campaign is manually terminated by an administrator or referring member, or the potential member becomes a registered member.

A number of security measures may also be employed by an administrator to ensure that the email generation campaigns are not abused. One security measure is a limit on the number of outstanding marketing campaigns that are active for a referring member. For example, a referring member may be allowed roughly 5-20 (e.g., 10) active referral campaigns. The referring member may be provided with the ability check the status of the email campaigns at any time and may terminate campaigns in excess of a campaign limit. Restrictions may be lifted or modified automatically or manually when a particular number or percentage of campaigns have been successful or if a number or percentage of campaigns have completed without any complaint from the potential members.

In some embodiments, a reward system may be provided to members. Rewards may be given, for example, to members that successfully refer other members, view content, engage in events, or participate in any feature or promotion of a community. A reward system may, for example, be point based such that particular actions correlate to particular point amounts. Points can be redeemable for additional content and other awards (e.g., prizes). If a reward system is in place, demerits can be given if a referring member receives a complaint from a referred member stating that, for example, the referred member does not know the referring member. Demerits can take the form of, for example, points being subtracted from a members point total.

An online community may take the form of an online magazine. Such an online magazine may, for example, correspond to a magazine that is in print. The online magazine, however, may include content that is free and available to all users and/or registered members and content that is available to qualifying members and/or users. A member may qualify for such content if, for example, the member redeems a particular number of points, meets a reward threshold (e.g., accumulates a particular number of points), pays a particular fee, or is a paid subscriber of the online and/or print magazine. Thus, an online community may be, in itself, a referral program for the print magazine. An online magazine may offer users a chance to experience a portion of the print magazine in an effort to develop the users into subscribers of the printed magazine.

Particular web content and awards may be categorized as assets. For example, online chats with editors, athletes, or celebrities, webcasts, downloadable software, and digital music (e.g., MP3 audio files) may be considered assets. Such assets may be provided as awards to qualifying members (e.g., members that have reached a particular point total). Assets may be manually updated, added, and changed at any time by an administrator. A referral email generator may include links to such assets. Assets may be categorized and only particular referred members may be provided with emails that include links to assets from particular categories. Thus, an email generator tool may, for example, depending on the marketing campaign pick one or more particular assets from particular categories and generate links in a referral email to this content. A referring member may also be able to pick what assets are provided to a user (e.g., by choosing a particular number of assets from a particular list of assets). Furthermore, when a member earns access to an asset, that member may be provided with the opportunity to start a marketing campaign for a potential member that includes a link to the earned asset. Thus, a member may not only earn access to an asset, but earn the ability to provide access to a particular number of associated prospects or potential members (e.g., 1, 2, or all).

Members may earn points for any number of activities (e.g., successful referrals, views, contributing content). Such points, however, may or may not be utilized for redeeming rewards. For example, points may be awarded to a user in a manner that reflects the user's standing, activeness, or participation level in the community. Accordingly, members that have a high value to the community may be treated differently than members that have a low value to the community.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an email generating topology for a referral email generator constructed in accordance with the principles of the present invention;

FIG. 2 is a process flow chart for a referral email generator constructed in accordance with the principles of the present invention;

FIG. 3 is a process flow chart for a referral email generator constructed in accordance with the principles of the present invention;

FIG. 4 is a process flow chart for a referral email generator constructed in accordance with the principles of the present invention;

FIG. 5 is a process flow chart for a referral email generator constructed in accordance with the principles of the present invention;

FIG. 6 is a process flow chart for a referral email generator constructed in accordance with the principles of the present invention;

FIG. 7 is an email chart for use by a referral email generator constructed in accordance with the principles of the present invention;

FIG. 8-17 are referral emails constructed in accordance with the principles of the present invention;

FIG. 18 is a graphical user interface of a personal page of a member of an online community constructed in accordance with the principles of the present invention;

FIG. 19 is a graphical user interface of an online community constructed in accordance with the principles of the present invention;

FIG. 20 is a graphical user interface of an online community constructed in accordance with the principle of the present invention; and

FIG. 21 is a graphical user interface of an online community constructed in accordance with the principles of the present invention.

### DETAILED DESCRIPTION OF THE INVENTION

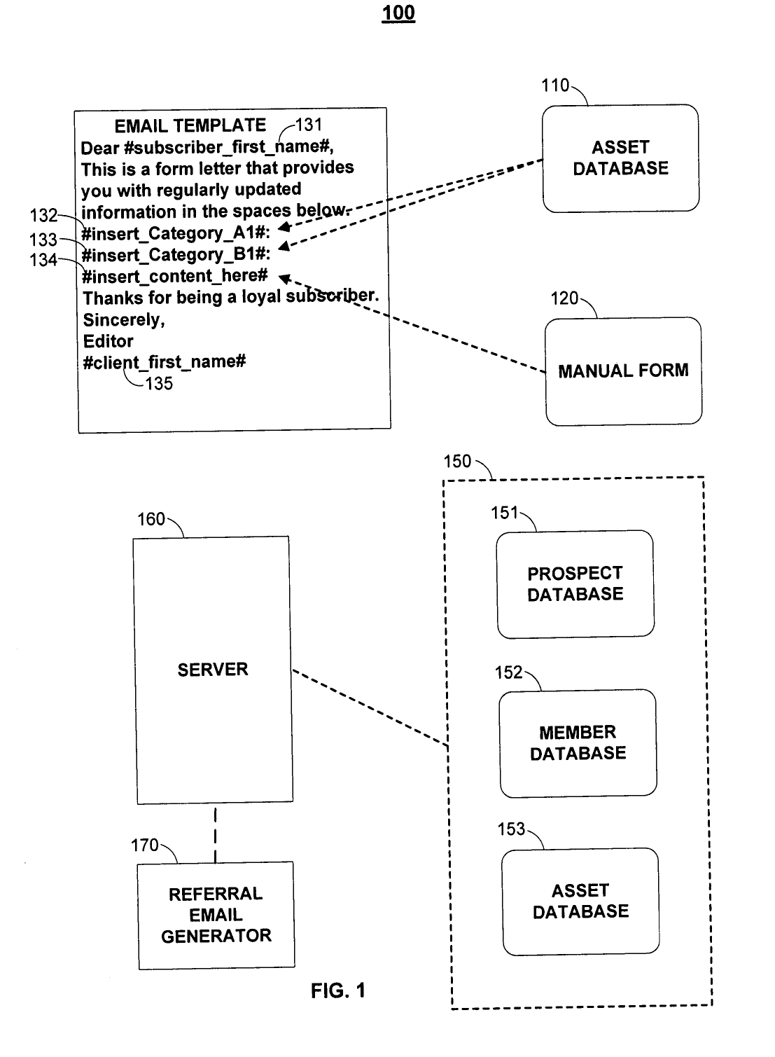

FIG. 1 shows email generating topology 100 for providing email template 130 from various sources of information. Information sources may include, for example, server 160, database 110, manual form 120, or memory 150 storing prospect database 151, member database 152, and asset database 153. Memory 150 may include any storage mechanism or storage device, including RAM, ROM, hybrid types of memory, hard drives, optical drives, and tape drives.

A particular email template, such as email template 130, may be assigned to a particular stage of a campaign. Stages may be separated by events. An event may be, for example, that a particular amount of time passes after an email has been generated and sent without the referred member viewing an asset or becoming a member. An event may alternatively be, for example, when a potential member clicks on a link, visits an asset that is web content, and the visit is recognized as being from the potential member.

Email template 130 may include static information and dynamic information. Static information may be set for the template. Dynamic information may be changed in the template. Such dynamic information may include information that a user can edit. Such dynamic information may also include assets themselves or links to assets that are stored in a database such as an asset database, such as asset database 110. Assets can be categorized and email template 130 may include code (e.g., mark-up language code, such as HTML, XML, or any other suitable code) that inserts a particular asset, a random asset, a particular asset in a particular category, a random asset in a particular category, or an asset that meets a variety of rules into the template. As such, for example, an email template may include code that inserts the link to a webcast with the closest date of broadcast that is associated with a particular category. Categories may be associated with, for example, members of a particular sex (e.g., male and female), members of a particular age group (e.g., under 18 and over 18), members having a particular association with a referring member (e.g., a friend or relative), members having a particular job (e.g., coach or teacher), or asset types (e.g., webcasts, live chats, private articles matching particular criteria, or any other human-perceivable media).

Email template 130 includes dynamic information 131, 132, 133, 134, and 135 in the form of database tags for inserting variable information stored in one or more databases, such as database 110. Email template 130 may also include pre-formatted text, graphics, embedded audio, video, and any other suitable content. In some embodiments, email template 130 may include paid advertising from a sponsor. Dynamic information 131 includes information about the potential member (e.g., the first and/or last name of the potential member). Dynamic information 132 and 133 may include the links to categorized assets. Dynamic information 135 may include information about the referring member (e.g., the referring member's first and/or last name, nickname, screen name, handle, or user identification). Dynamic information 134 may include a call to see if an administrator has added any additional content for email template 130 or a call to see if the referring member has added any additional content to email template 130. Dynamic information 133, for example, may be stored to a database for retrieval by template 130, or entered directly into template 130, by manual form 120 provided to an administrator, moderator, or referring member. Referral email generator 170 may then generate an email from email template 130 and send the generated email to the potential user. Referral email generator 170 may generate emails using a merge routine that merges information from memory 150 and/or database 110. Although referral email generator 170 is shown external to server 160 in the example of FIG. 1, in some embodiments, referral email generator 170 is a component of server 160. For example, referral email generator 170 may be a software application or software routine executing on server 160. In other embodiments, referral email generator 170 is a separate email server configured to generate and send email communications.

Information about an asset, or any other information such as prospect and member information, may be stored in a single server (e.g., server 160) or database (e.g., memory 150). Alternatively, particular information may be stored in multiple servers and/or databases associated with the information. For example, asset information may be stored in memory 150 of server 160 in asset database 153, member information may be stored in member database 152, and potential member, or prospect, information may be stored in prospect database 151.

Server 160 or referral email generator 170 may be configured to create HTML email templates, such as email template 130. Although only email template 130 is shown in the example of FIG. 1, in actual implementations a plurality of email templates may be defined. The email templates may be part of a viral marketing campaign designed to use interpersonal communication and word-of-mouth to influence member enrollment. Server 160 or referral email generator 170 may also be configured to feed specially tagged content into email templates automatically from memory 150 and/or database 110 and specify recipient groups as well as the timing of communications to members and potential members, as described in more detail below.

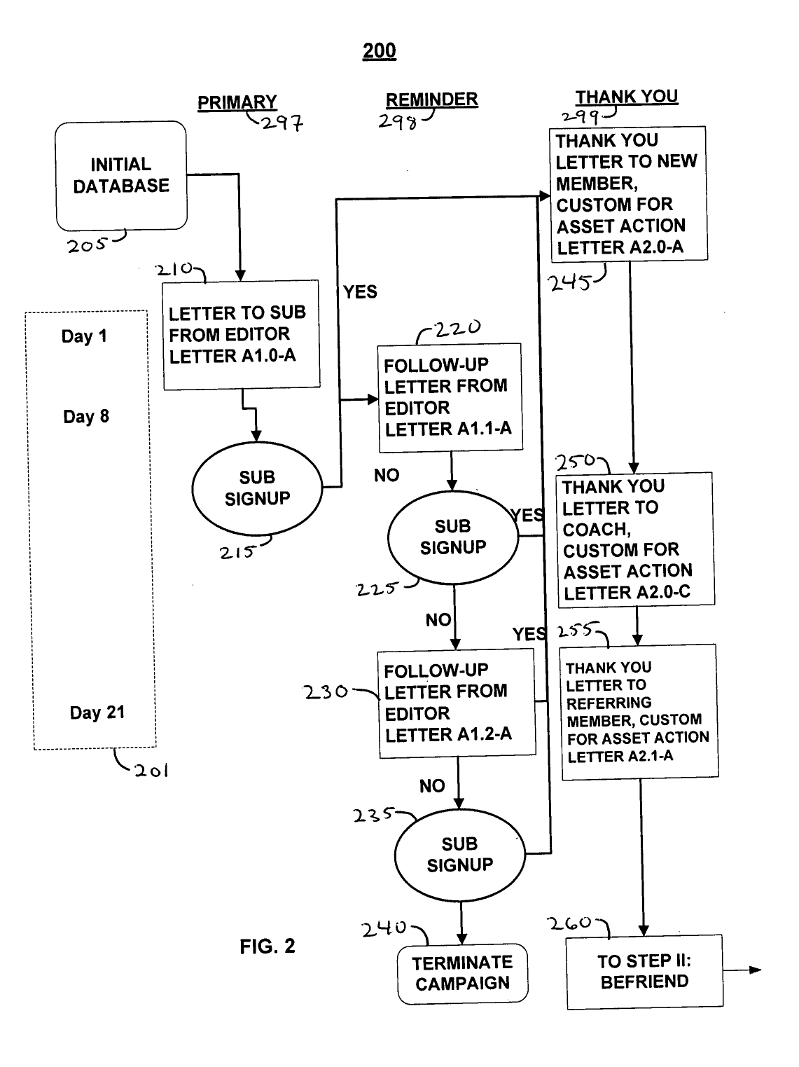

FIG. 2 shows illustrative email campaign process 200 that may include first (“primary”) phase 297, second (“reminder”) phase 298, and third (“thank you”) phase 299. Phases 297, 298, and 299 may be utilized to categorize the communities relationship to a potential member. For example, first phase 297 may be a primary phase in which someone (e.g., a referring member) has expressed interest that the referred member may be interested in the community. Emails generated for a particular phase may include similarities with respect to other emails generated for a particular phase. For example, emails generated for a primary phase may be signed by both an authoritative figure of an online community (e.g., an editor) and a referring member. Later phases, however, may be signed just by an authoritative figure. Persons skilled in the art will appreciate that any letter may be signed by just a referring member and not an authoritative figure such that a potential member is more likely to accept the email as originating from a known source. An email campaign may move between phases dependent on, for example, the triggering of particular events. For example, if a potential user does not respond to an email campaign for a predetermined period of time, or after a particular number of emails have been mailed, then a phase of the campaign associated to such events may be initiated.

Persons skilled in the art will appreciate that any email may take the form of a physical letter and vice versa. Additionally, particular phases, or particular communications, may be defined by a referring member or administrator as utilizing physical letters while others are defined as utilizing electronic communications. For example, a thank you phase may be initiated after a potential member registers as a member and, when such an event occurs, the thank you communication may take the form of a physical letter being sent with a physical asset, such as a postcard, DVD, or CD-ROM (e.g., instead of an electronic asset). A member qualifying for a thank you letter may be provided with a list of physical assets from an asset database and may be provided with the opportunity to chose one, or a particular number, of physical assets as a reward for registering. Users that meet particular rules such as registering, paying for paid services such as subscriptions, referring a member that registers, or referring a particular number of members that registers may be sent communications to receive any combination of electronic and/or physical assets.

Step 210 of process 200 includes generating a letter from database 205. Step 210 may be initiated by, for example, an administrator of an online community, autonomously by an online community, or a referring member. Step 210 may generate and send a letter to a potential member. Step 215 may wait a particular amount of time (e.g., 5-15 days) before sending a follow up letter in step 220. If a user registers for the offered service, however, step 245 may be initiated and a thank you communication latter may be generated at step 245. One or more electronic or physical assets may be included in the communication. Step 245 may also determine whether or not the registered user fits into a particular group. For example, if the new user is determined to be a coach, step 250 may be initiated and a referral letter for coaches may be generated. If the potential member was referred by a member, a thank you communication may be generated at step 255 and sent to the referring member. A campaign may include step 260 of befriending a member after that member signs up. Thus, a communications campaign may continue even after a user has registered and is sent a thank you communication and a number of assets.

If a potential member does not register at step 215 then step 220 may be initiated. Step 220 may generate an email different from the email generated in step 210. The email generated at step 220 may reference the email that was previously sent. If the potential member registers at step 225 then step 245 may be initiated. Else, for example, another follow up communication may be generated and sent to the potential member at step 230 after a particular period of time, and if the user still fails to register at step 235, the campaign may be terminated at step 240. A referring member may be provided with the ability to view the status of a referral campaign for a potential member referred by the referring member. For example, a referring member may be able to view whether or not the campaign is active, the phase the campaign is in (e.g., primary, reminder, thank you, cancelled), and the letters communicated to the referred member.

Persons skilled in the art will appreciate that the timing between particular communications may be at fixed or variable intervals. For example, communications may be generated and/or sent every X number of days, hours, or second, where X is any positive number. Alternatively, communications may be generated and/or sent at time periods that correspond to particular events or phases of an email campaign. For example, a reminder letter may be generated and/or sent a week after the initial communication was sent. A second reminder may then be generated and/or sent two weeks after the first reminder was sent. Thus, reminder letters may be sent at an exponentially increasing time delay. In the example of FIG. 2, timeline 201 shows an illustrative sending schedule. Alternatively, reminder letters may be generated within a particular amount of time of an event happening. For example, a reminder letter may be sent 12 hours after a user that has received a communication visits the website. Persons skilled in the art will appreciate that email campaigns may also be utilized to market services to registered members or any potential user.

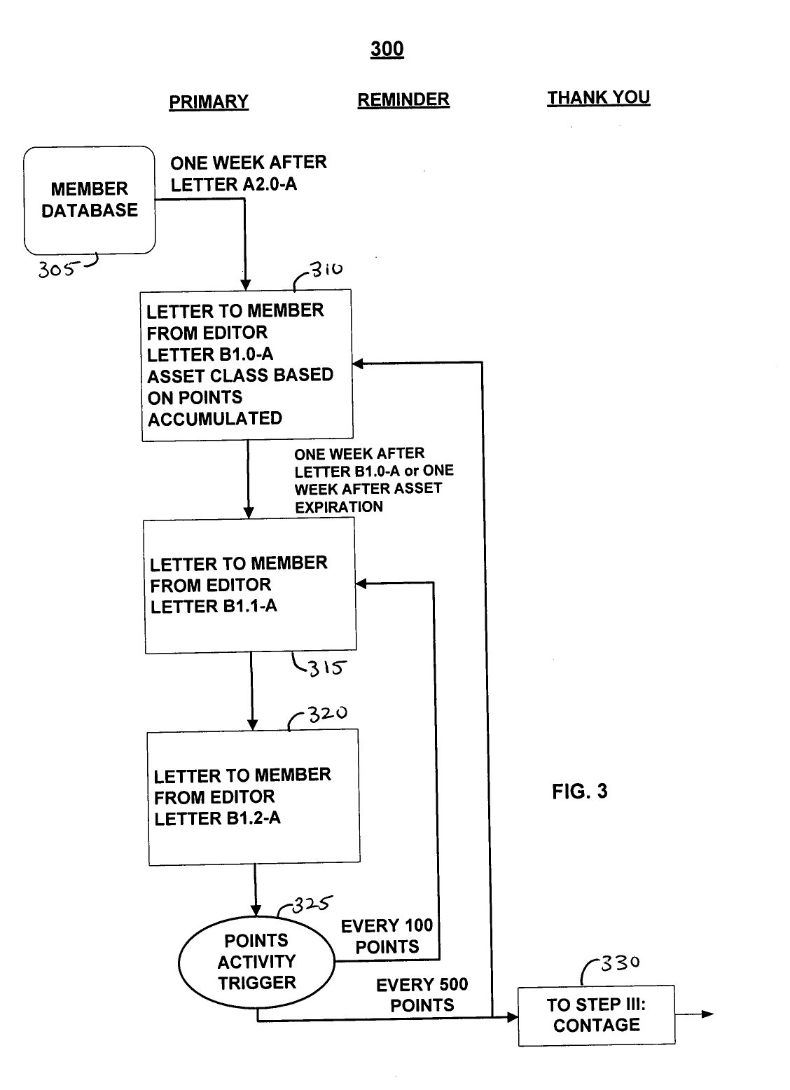

FIG. 3 shows process 300. Process 300 may be initiated at any suitable time. For example, process 300 may be initiated after a potential member registers or purchases a service. Process 300 may also be initiated, for example, after a registered member purchases a service/product. For example, one week after a coach registers to be an insider of a print magazine by being provided with content of the magazine's online community, a communication may be generated at step 310 using information from database 305 (e.g., a member database). The letter may include an asset based on the number of points the member has accumulated in the member's first week as a registered member. The letter may additionally or alternatively include an asset based on points the referring member has accumulated to date such that the referred member is provided with the opportunity to experience assets the user can potentially obtain. The member may be provided with a list of all available assets. Alternatively, the member may be provided with a list of categorized assets and may be provided with the opportunity to obtain one or more assets from each category. Assets may also be displayed to the member that the member does not yet have the points to obtain and the number of points needed to obtain the assets. Assets that are given to members based on points may, for example, be given when point thresholds are met such that points do not have to be subtracted from a member's point total. Alternatively, points can be redeemed and subtracted from a member's point total in order to obtain an asset.

Virtual assets may be sent to members every time a particular interval of points have been accumulated. For example, a letter may be generated every 100 points at step 315. Step 310 may be initiated, for example, every 500 points. Additional letters may be generated after a member joins. For example, letters may be sent to a member at step 320 at a particular time before a virtual asset expires (e.g., a webcast airs) to let the member know how many points are needed by a particular date to be able to select the asset. Point activated triggers 325 may be included anywhere in process 300. After a member uses the community (or assets) to a particular degree, then the email campaign may send a request that the member try to refer friends, family, and/or peers at step 330.

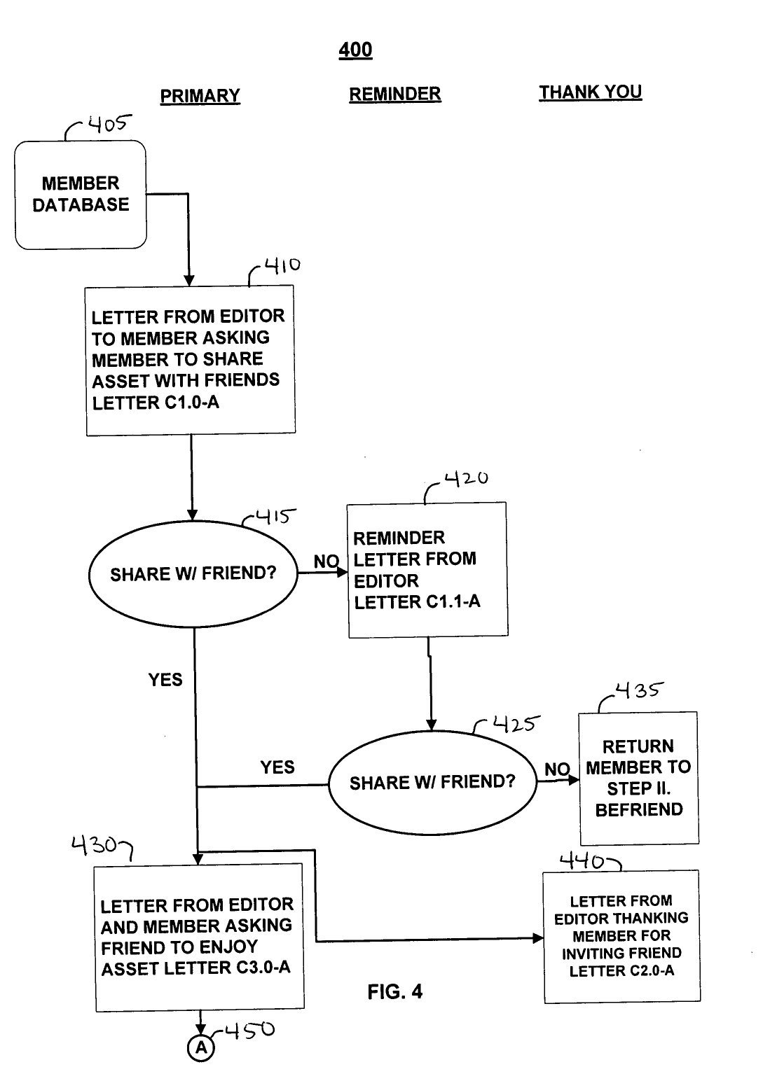

FIG. 4 shows process 400 that may be initiated at any suitable time. Step 410 may be initiated, for example, for an email to be generated to a member asking that member to share an asset with a friend. Step 410 may generate an email by using, for example, information from member database 405 or any other information. An email, or other communication, generated and sent to a member may be initiated after a particular period of time or after an event occurs. For example, a referral request communication may be initiated after a particular number of days, hours, or seconds after a member registers. As per another example, a referral request may be initiated after a member accumulates a particular amount of points. As per yet another example, a referral request may be initiated after a member logs into the website a particular number of times (e.g., 100). Alternatively still, a referral request may be generated after a member earns an asset such that the member may be provided with the opportunity to give a similar asset to a friend.

If a user is provided with a referral request, step 415 may wait for an answer for a particular amount of time before initiating another request in step 420. Persons skilled in the art may appreciate that referral requests may be generated whenever a member enters in contact information for a person not known to the community or not yet registered. Step 425 may wait a particular amount of time for an answer to a second referral request. When a member accepts a request to refer a potential member and/or initiates the generation of a referral letter, a referral letter may be generated at step 430. If the member does not accept the request to refer a potential member, the member may be returned to process 300 (FIG. 3) at step 435. The referral letter that is generated may be a letter signed by both an authoritative figure (e.g., an editor) of an online community and the referring member. The referring user may select a particular number of assets that the potential member may appreciate and the referred member may be able to select one, a portion, or all of the selected assets. Having a referring member select assets may be beneficial since the referring member may be in a better place to judge the tastes of the potential member. After step 430, a new referral campaign may be started in process 450 for that potential user. A letter may also be generated and sent in step 440 from the editor to the referring member thanking the referring member for inviting a friend. One or more virtual assets may be provided in such a letter as a reward. Such virtual assets may be stored in an asset database in a category associated to sending out referral emails to prospective members.

Persons skilled in the art will appreciate that a checkbox to automatically generate a referral letter may be provided to a user when that user initiates a graphical user interface to add contact, or other, information for a potential member.

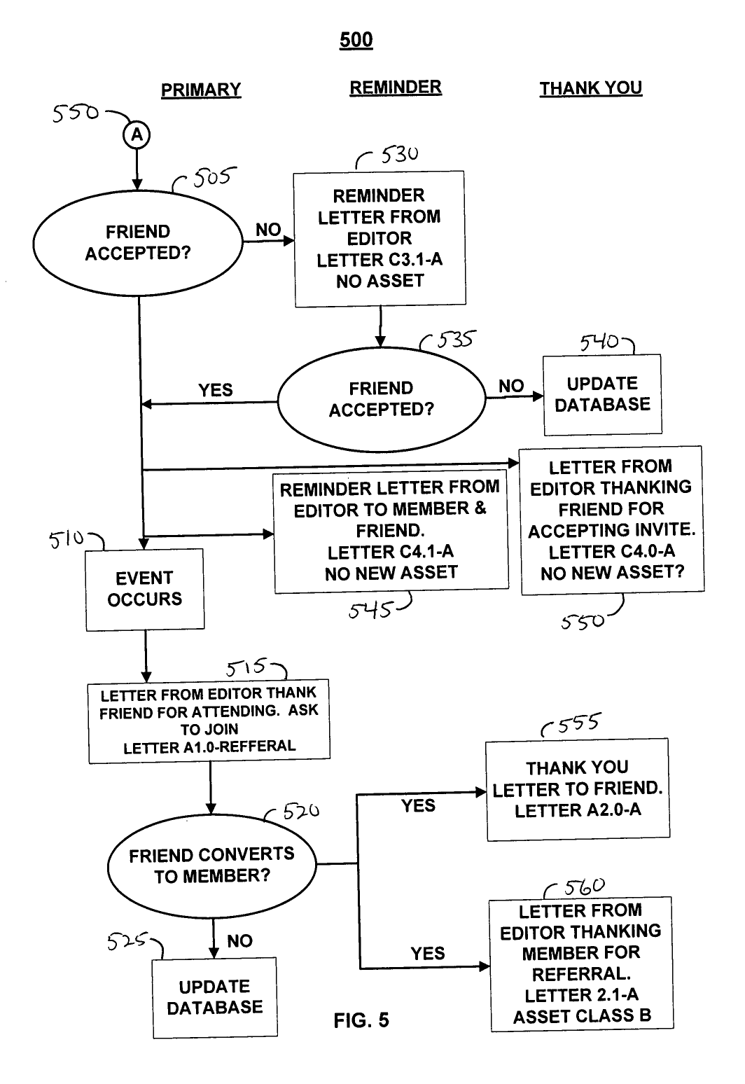

FIG. 5 shows process 500 that may be initiated at any suitable time. Process 500 may be initiated, for example, at stage 450 of FIG. 4 (e.g., stage 550). For example, process 500 may be initiated when a friend of a member has accepted a referral letter and has become a registered member. Registering for membership may include, for example, entering in personal information into a graphical user interface as well as associating a username and password to the personal information. If a friend has not accepted a referral letter at step 505, a reminder letter may be sent at step 530. A period of time may go by at step 535 to wait for a reaction to the generation of a reminder letter at step 530. At any time, a database may be updated at step 540. For example, a potential member profile may be set up in a database and may be updated by any process as to the status of letters generated for the potential user.

Persons skilled in the art will appreciate that providing a prospect member profile may expedite the registering process for a member. Particularly, if a potential member selects from a letter a link that takes the potential member to a registration page, information may already be filled in text boxes, or displayed to the user, that are included in the potential member profile created by one or more members of the community (or obtained from other sources). A user may also be provided with the opportunity to modify the information already present in the potential member profile as well as delete the potential member profile. Similarly, a referral campaign that is terminated may automatically cause, for example, the corresponding potential member profile to be deleted or portions of the potential member profile to be deleted.

Saving portions of a potential member profile may be beneficial even if the user requests that the profile be deleted. For example, saving the email address of the user may ensure that no other member may begin a referral action towards the potential member that requested profile deletion. In this manner, a member that initiates a referral request may not cause an email to be generated if the potential user being referred had previously requested that communications cease and/or the potential member profile be deleted.

A prospective member that accepts the services/products offered in an inquiry letter may be, for example, sent a thank you letter at step 550 and/or a reminder letter at step 545 to both the referring member and the newly registered, previously prospective user. Thus, assets can be shared between both a referring member and a potential member. For example, a member may be told that if a prospective member is referred and ultimately registers, both the referring member and the referred member may be given an asset (e.g., exclusive web content) or a particular number of point redeemable for assets. Letters can be generated and sent to referred members (and referring members) when any suitable event or events occur at step 510. For example, after a referring member has used an asset (e.g., viewed exclusive web content) another thank you letter may be generated and additional assets and/or points may be given to either the referring member, referred member, or both at step 515. After a relationship is established with the referred member, for example, the process may continue and the referred member may be asked to become a particular type of member (e.g., a paying or subscribing member) at step 520. Persons skilled in the art will appreciate that any referral letter may ask a potential member simply to use an asset without registering. Once a user views an asset (e.g., access to privileged web content), for example, then the user may be asked to become a non-paying member or a paying-member. Databases can be updated at any suitable time such as, for example, at step 525 if a user or member changes his/her member profile. Thank you letters may be generated at steps 555 and 560 after the referred member becomes a particular type of member (e.g., a paying or subscribing member) at step 520.

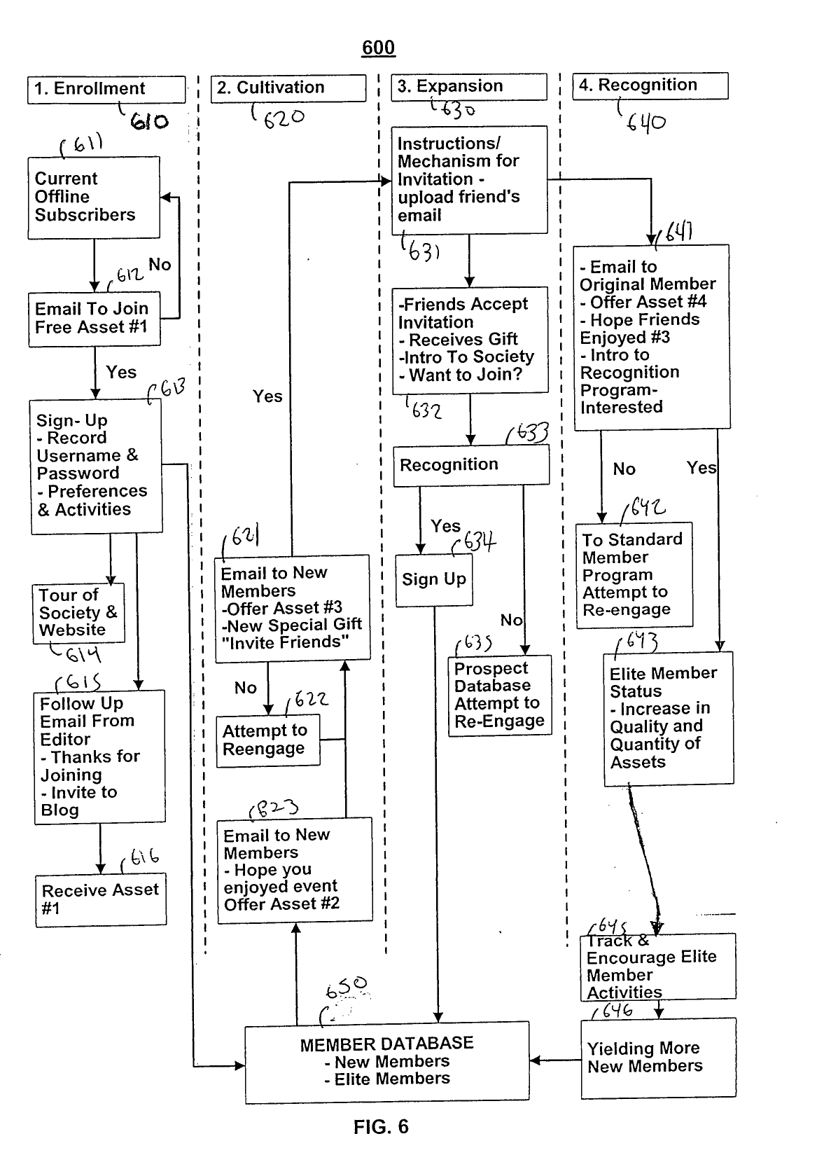

FIG. 6 shows process 600 that may include enrollment phase 610, cultivation phase 620, expansion phase 630, and recognition phase 640. Phase 610 may start with step 611 and continue to step 612 where a prospective user is asked to join a community and/or accept/purchase a service. The prospective user may also be offered one or more assets. Step 613 occurs if a user, for example, accepts the invitation and accepts user input for creating and/or modifying a member profile and any other features of a community. A virtual tour of the website and/or online community may be provided at step 614. Follow up emails offering additional assets may be sent at step 615, and assets (e.g., selected assets) may be received at step 616. Any step may provide points to a referring member or a referred member.

A member database may be updated at any suitable time at step 650. A thank you email may be generated after a user accepts and/or experiences an asset at step 623 and one or more additional assets may be offered. Additional assets may be offered at step 621 and a request for referral may be included in a communication generated from step 621. Inactive members may be reengaged at step 622 by, for example, generating and sending one or more additional communications to the member, offering one or more additional assets, or any other suitable reengagement mechanism. Step 631 may allow a referring member to enter in information about a prospective member, and step 632 may occur after a prospective user accepts an invitation to join. Recognition of the referred member joining the community or accepting an asset, and the referring member successfully referring a member, may be accomplished at step 633 (e.g., by generating a new communication). If the recognition at step 633 is successful, the referred member may be enrolled at step 634 and a new member profile created and added to the member database at step 650. If the recognition at step 633 is unsuccessful, the referred member may be reengaged at step 635 by, for example, generating and/or sending one or more additional communications, offering additional assets to the referred member, or both. The referring member may be sent an email at step 641 in which one or more assets are offered, for example, as a result of the entry of prospective member information at step 631. A variety of referral programs may be selected by a member. And, different referral programs may be assigned to members dependent on information about a member. For example, coaches may be provided with different assets to offer prospective members than players. Members that have a large number of successful referrals may be given higher quality assets to offer than members with a lower number of successful referrals (e.g., below a particular threshold). Steps 642 and 643 may be initiated, for example, dependent on the type of referral program a member is qualified for. Member activities may be tracked and awarded at step 645 such that the possibility of successful referrals may increase at step 646.

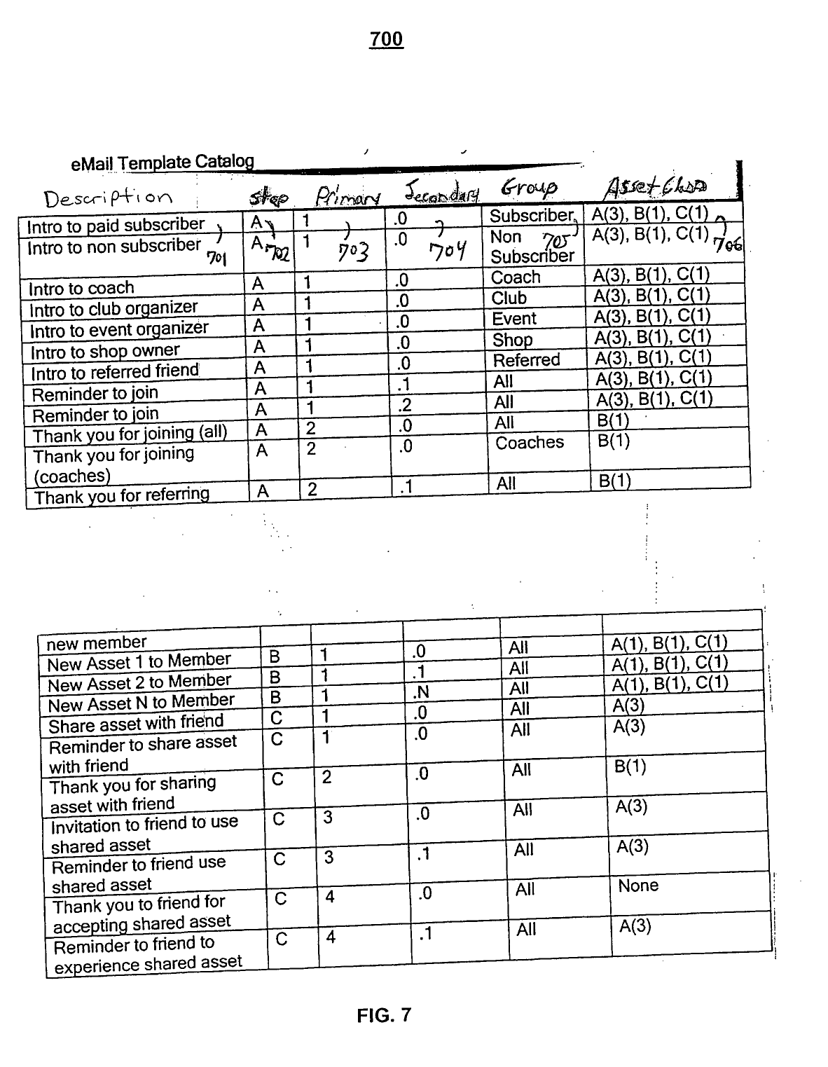

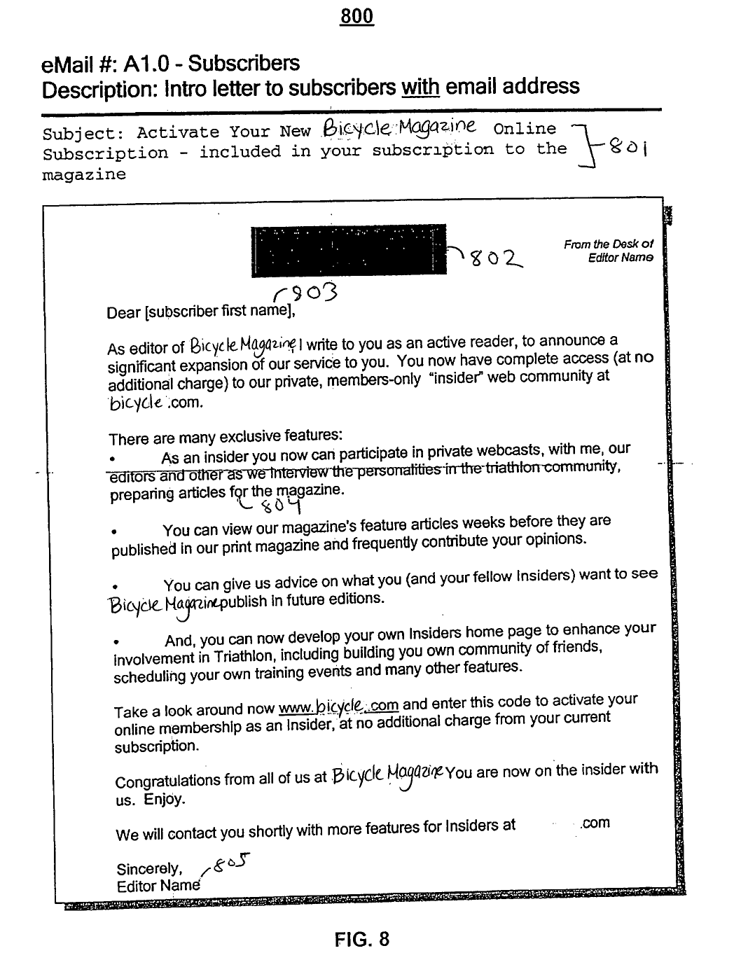

FIG. 7 shows email template catalog index 700 that includes a variety of email templates that may be used for various phases in various, intelligent, or pre-defined orders for particular groups offering particular services/products as well as assets. Illustrative email communications corresponding to the template entries in email template catalog index 700 are shown in FIGS. 8-17. Email template catalog index 700 may include description column 701, step column 702, primary sequence column 703, secondary sequence column 704, group column 705, and asset class column 706. More or less columns may be defined in email template catalog index 700 than shown in the example of FIG. 7 in other embodiments. Description column 701 may include a unique alphanumeric name or description for the email template. Step column 702 may include one or more phase or step designations to which the email template is applicable. In some embodiments, there may be three steps, “A”, “B”, and “C”. Step A email templates may be designed to attract and bring in new members and may include introductory templates to encourage enrollment or membership. Step B email templates may be designed to befriend and engage members with a positive experience by, for example, presenting new assets to already-enrolled members. Step C email templates may be designed to turn members into advocates on behalf of the community and allow them to share their experiences with friends and potential new members. Within each step, there may be a series of events based on custom business rules.

Primary sequence column 703 and secondary sequence column 704 may identify the sequence of email distribution. For example, template “A1.2” may identify a template associated with “A” step, “1” primary sequence, and “2”, secondary sequence. Email templates may be used to generate and send emails to potential members or enrolled members in order of the sequence number. For example sequence number 1.0 may be sent before sequence number 1.1, and so on.

Group column 705 may associate the corresponding template listed in name column 701 with a particular subset of the population, such as subscribers, non-subscribers, and referred members, or individuals filling a certain role or occupation (e.g., coach, organizer, etc.). Asset class column 706 may include a list of corresponding assets (number and/or type).

FIG. 8 shows illustrative communication template 800 that may take the form of (or be used to generate), for example, an electronic communication (e.g., an email or instant message) or a physical communication (e.g., a physical letter). The logo of the service/product/community provider may be included as logo 802. The referred members name may be provided as input 803. Features/services may be provided as input 804. The editor's name may be provided as input 805. Subject 801 may be the subject line associated with communication template 800. For example, subject 801 may be used as the subject line in an email or other electronic correspondence.

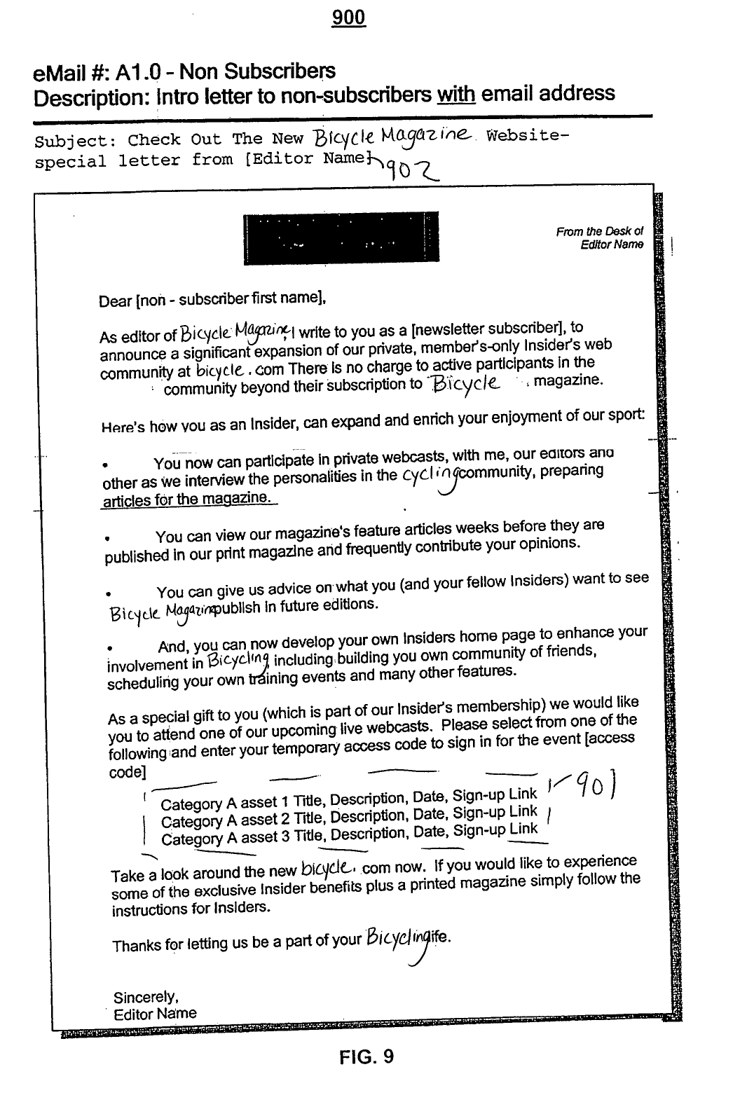

FIG. 9 shows illustrative communication 900 that may offer assets 901. The editor's name may be provided in the title or subject line of communication 900. For example, editor name 902 may be included in the subject line of an email or other electronic correspondence. The title or subject line of an email may change dependent on any type of information such as the referred member's name, referring member's name, or the current editor of an online community and/or magazine.

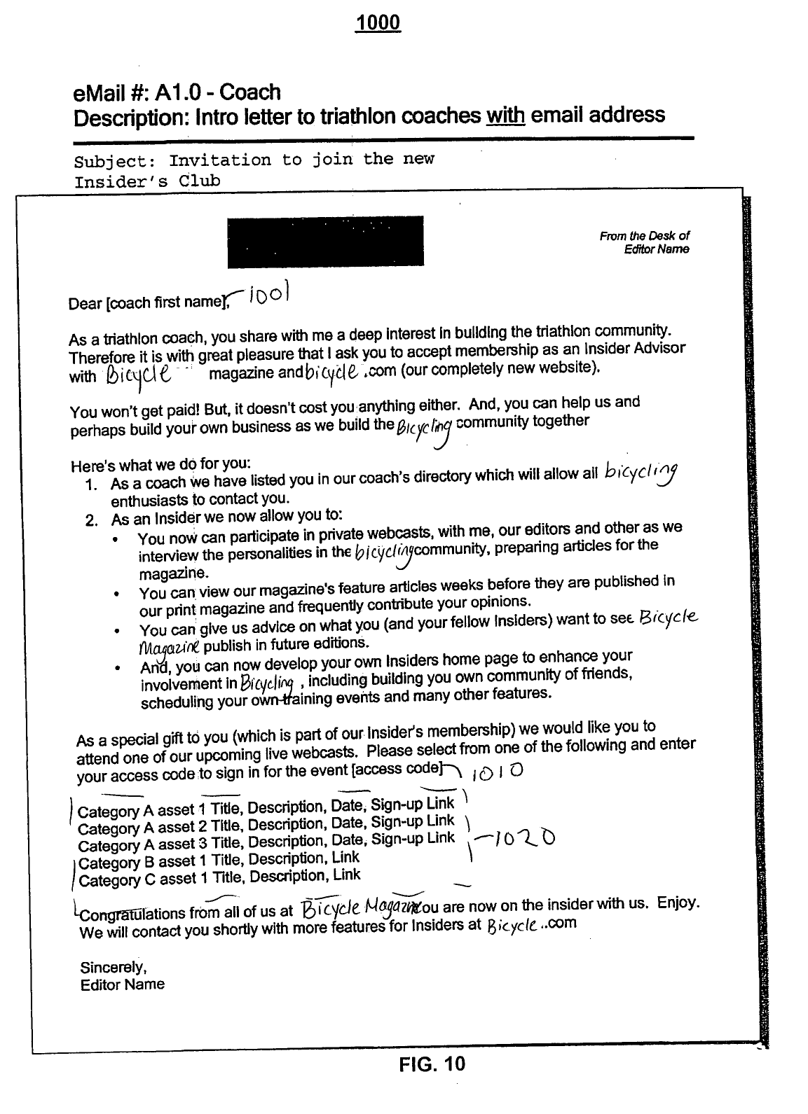

FIG. 10 shows illustrative communication 1000 that may include access code 1010 and assets 1020. Access code 1010 may allow a potential member to access one or more assets (e.g., one asset) from a list of assets. The access code may be utilized to allow a person to view an asset before registering for a website. The access code may be utilized to note when a user views an asset. For example, the potential member may select an embedded hyperlink in communication 1000 to access one or more of assets 1020. After selecting the hyperlink, the potential member may be prompted for access code 1010 in order to view or download the selected asset. The potential member's name, nickname, or handle may be displayed as name 1001.

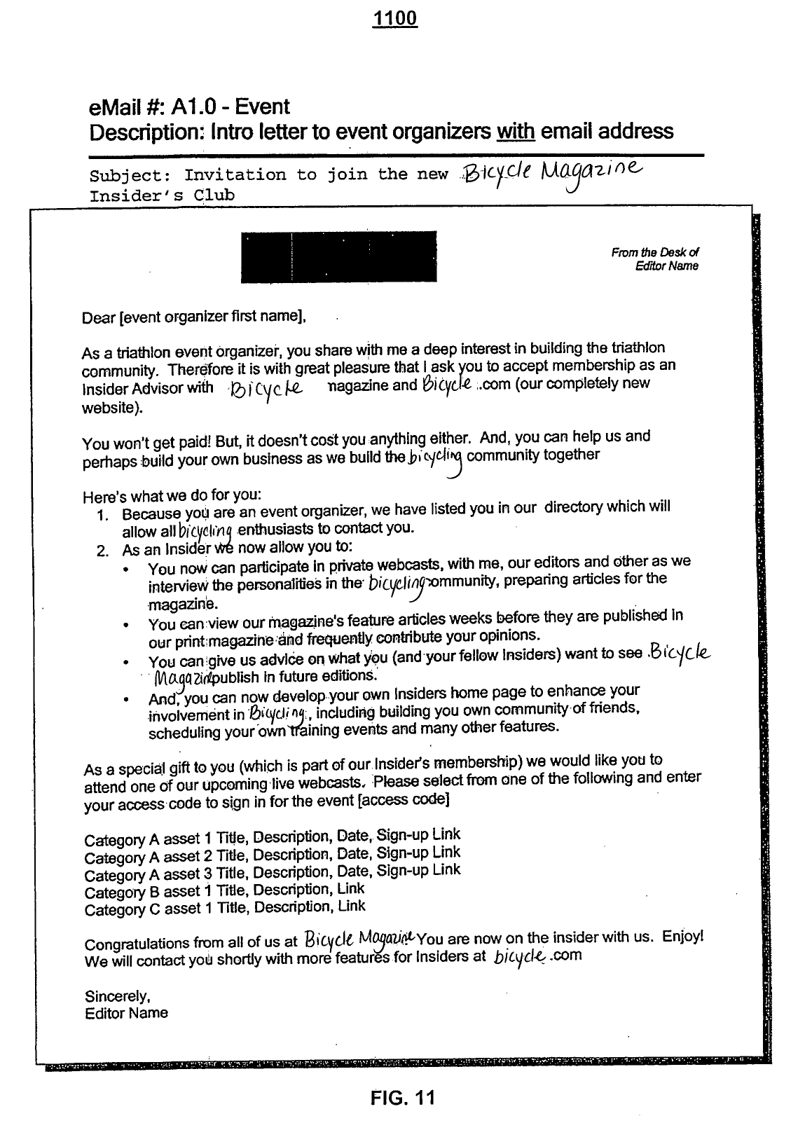

FIG. 11 shows illustrative communication 1100. Communication 1100, like communication 1000 of FIG. 10, may include an access code and link to one or more assets. In the example of FIG. 11, communication 1100 is an invitation to an event organizer to join a particular community.

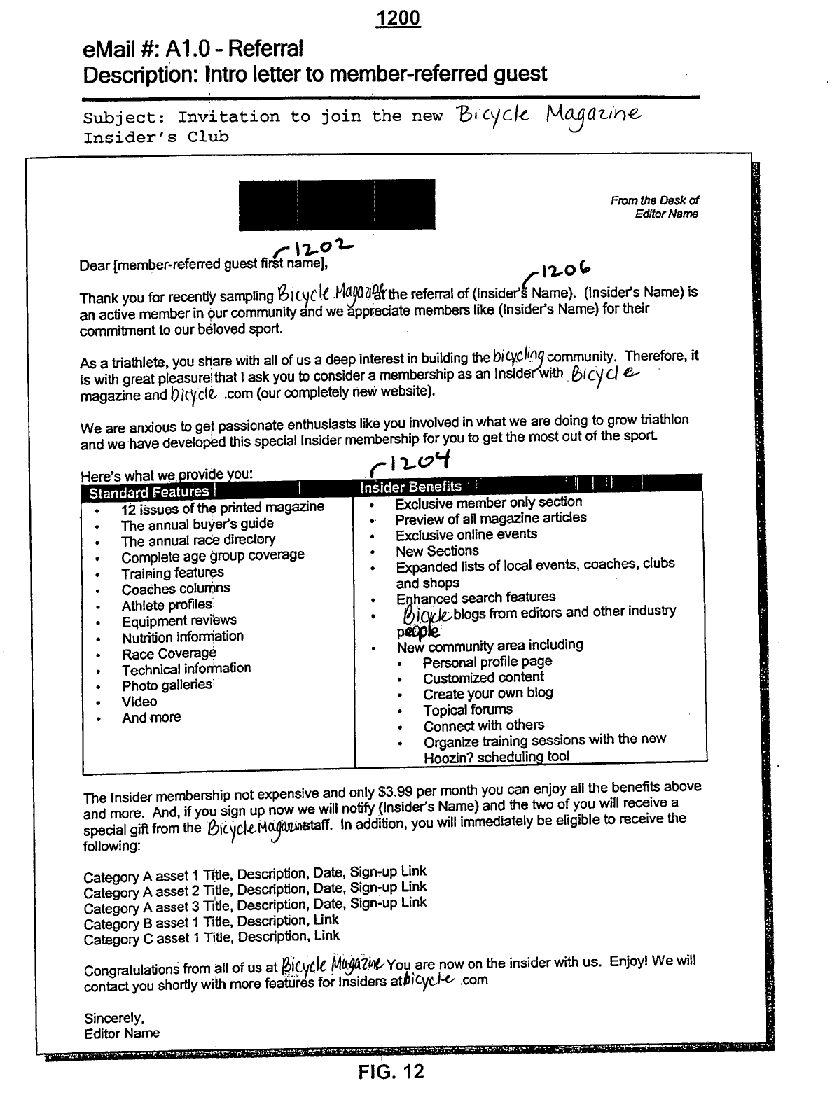

FIG. 12 shows illustrative communication 1200. Communication 1200 may be a communication to a member-referred guest or potential member. Name 1202 may display the first or full name of the potential member. Benefits comparison box 1204 may display a side-by-side comparison of the features and benefits of becoming an enrolled member. For example, communication 1200 may relate to a printed publication, such as a magazine for bicycling. Benefits comparison box 1204 may show the benefits of merely subscribing to the printed magazine along side the benefits of becoming an enrolled member with subscription to the magazine. Communication 1200, like communication 1000 (FIG. 10), may also include one or more assets for the potential member to choose from. Accessing the assets may be contingent on the potential member's successful enrollment as a new member. In addition, the referring member, whose name, nickname, or handle may appear at one or more locations within communication 1200, may also be credited with a certain number of points or assets. As shown in the example of FIG. 12, referring member's name 1206 may be strategically placed within communication 1200 to provide optimal exposure. This may enhance the likelihood of the potential member enrolling as a new member.

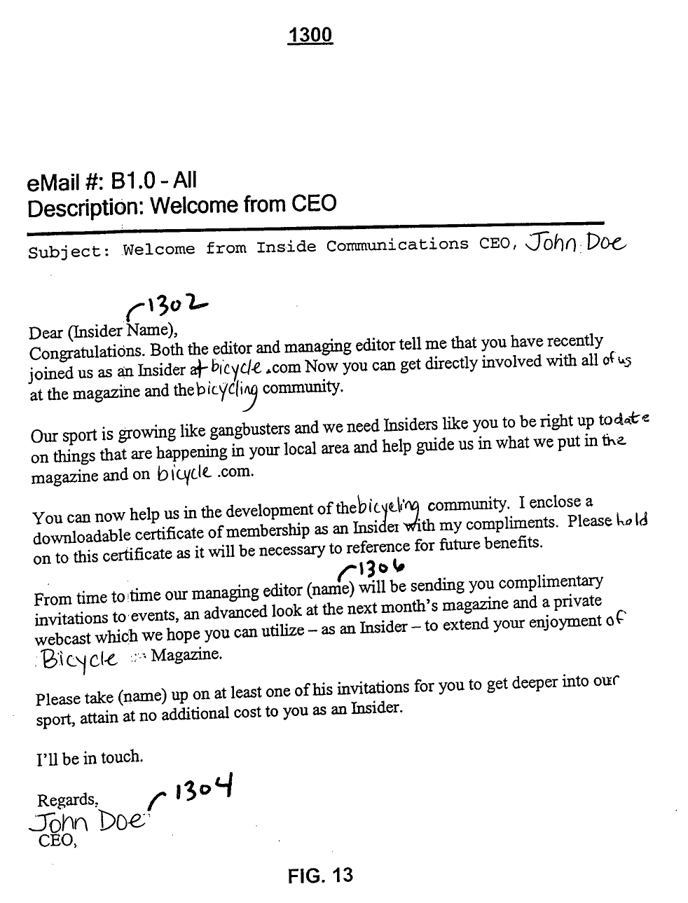

FIG. 13 shows illustrative communication 1300. For example, communication 1300 may be delivered to all newly-enrolled members. Communication may be personalized in several respects. First, member name 1302 may address the member to whom communication 1300 is directed. In the example of FIG. 13, communication 1300 is a letter from the CEO of a publishing company that published the magazine the member has recently subscribed to. The name and title of the author of the communication is displayed in closing area 1304. The managing editor of the magazine may also be introduced to the new member in name 1306. Communication 1300 may inform the member that communications and/or invitations will be delivered to the member in the future.

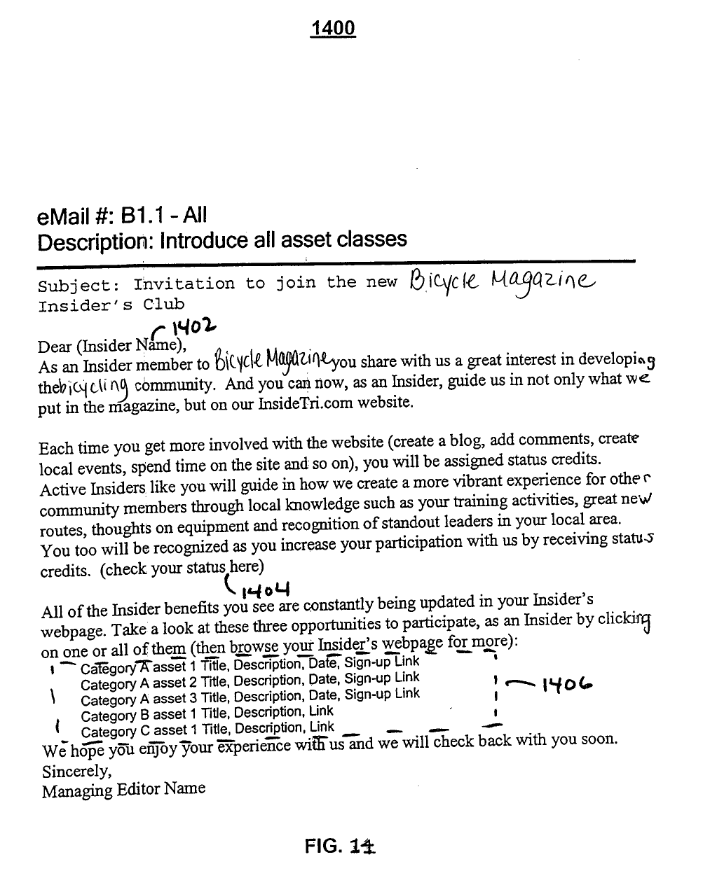

FIG. 14 shows illustrative communication 1400. Communication 1400 may introduce the member to all classes of available assets. Name 1402 may display the member's name, nickname, or handle. To check the member's status, including, for example, current points awarded, participation levels, and participation history, the member may select status link 1404. After selecting status link 1404, the member may be directed to a website where the member's profile information and points status may be viewed. As described above, assets may be divided into categories. Asset box 1406 may introduce the member to different assets in different categories as an incentive to become more involved with the community.

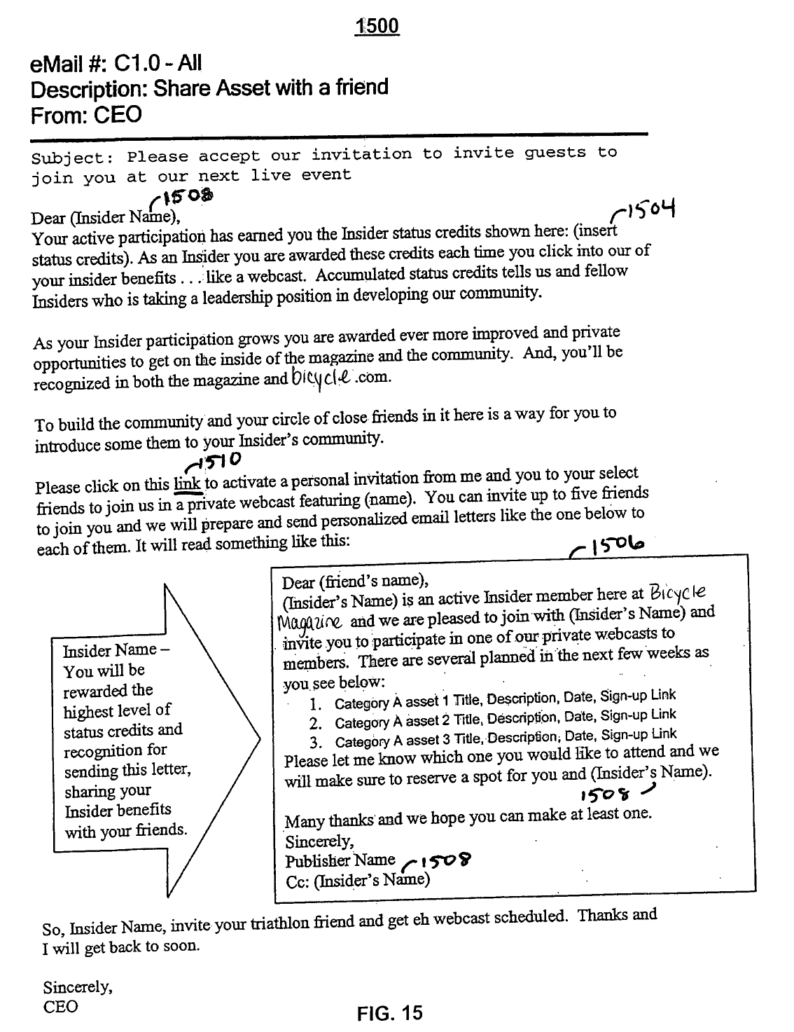

FIG. 15 shows illustrative communication 1500. Communication 1500 may be a communication invitation members to refer potential members or share an asset with a friend, co-worker, family member, or other social group member. Name 1508 may display the member's name, nickname, or handle. The member's current point credits may be displayed in status area 1504. A link may also be provided, in some embodiments, so that the user may access a website with additional information about the member's point totals, participation levels, and participation history.

In order for a member to share an asset with a friend or potential new member, the member may invite guests to join in certain assets. For example, a member may invite a friend to join the member in a private webcast. A preview of an email or other communication that will be sent to the member's friend is displayed in preview window 1506. To personalize the message, it may include both the member's name and the member's friend's name. As shown in the example of FIG. 15, name 1508 is included one or more times in preview window 1506.

If the member wishes to invite a friend, co-worker, family member, or any other social group member to join the member in the asset (e.g., private webcast), the user may select link 1510 or preview window 1506 to be directed to a webpage where the member may enter contact information for one or more friends and complete the invitation process.

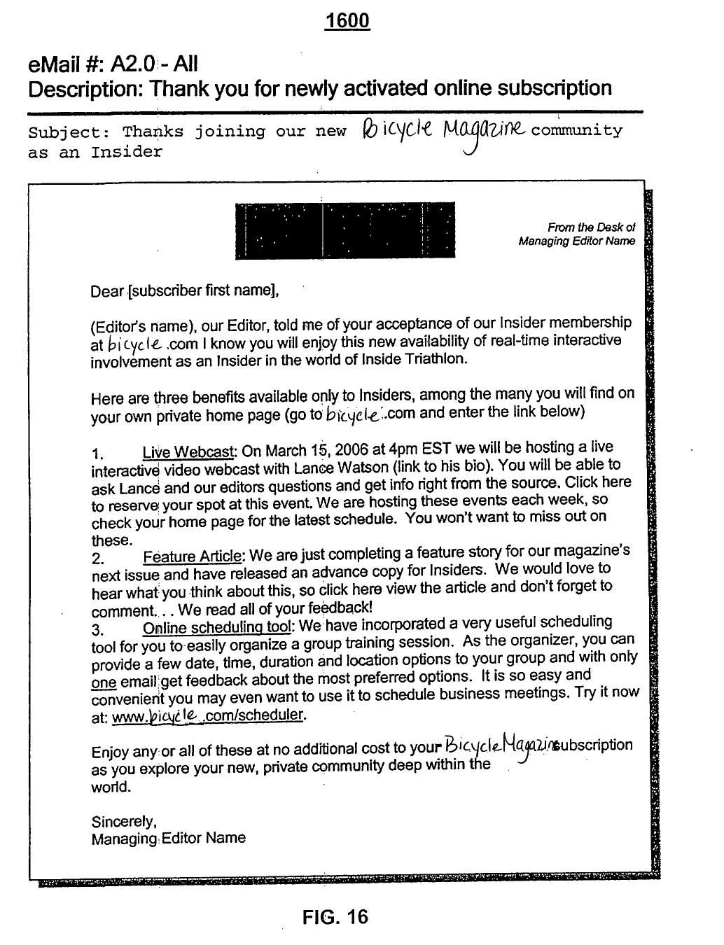

FIG. 16 shows illustrative communication 1600. Communication 1600 may be a thank you communication thanking a newly-enrolled member for joining. Communication 1600 may include personalized information, advertising, and any other suitable information. It may also introduce live webcasts, feature articles, and other tools and services only available to members.

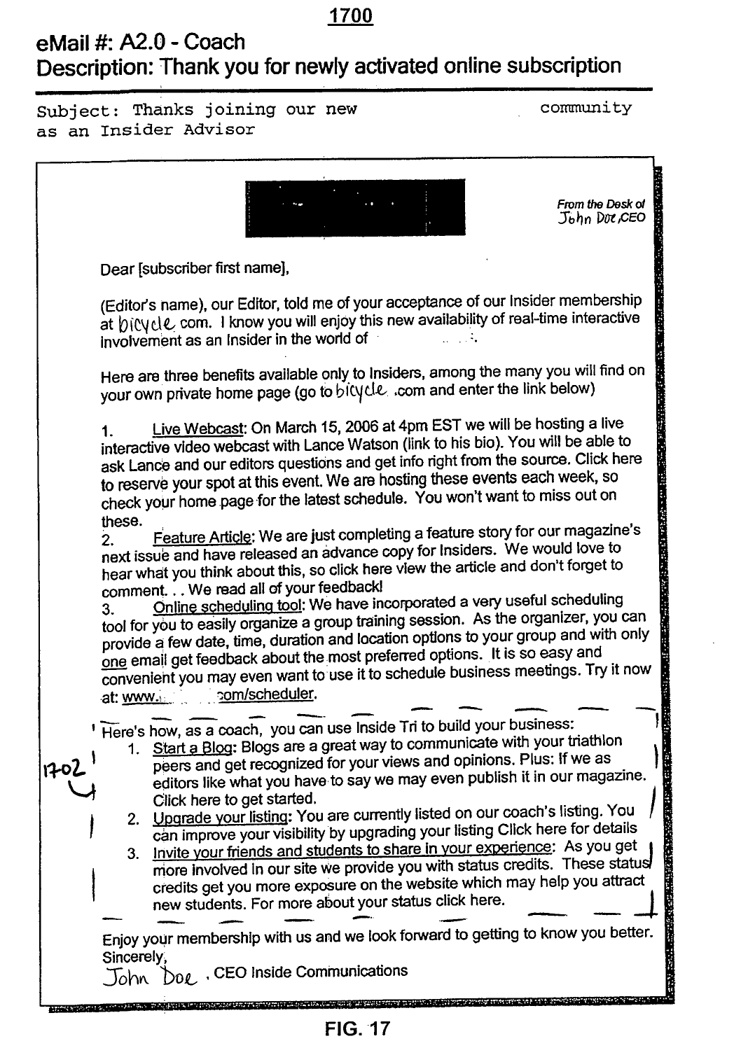

Similar to FIG. 16, FIG. 17 shows illustrative communication 1700. Communication 1700 may be a communication thanking a particular group of members for enrolling. For example, communication 1700 may be personalized to coaches. Communication 1700 may include all or part of the information displayed in communication 1600 of FIG. 16. Communication 1700 may also include group-specific information in area 1702. The information in this area may inform the member about features and benefits only available to the particular group (e.g., coaches). As shown in FIG. 17, coaches may start a web log, or blog, upgrade their listings, or invite friends and students.

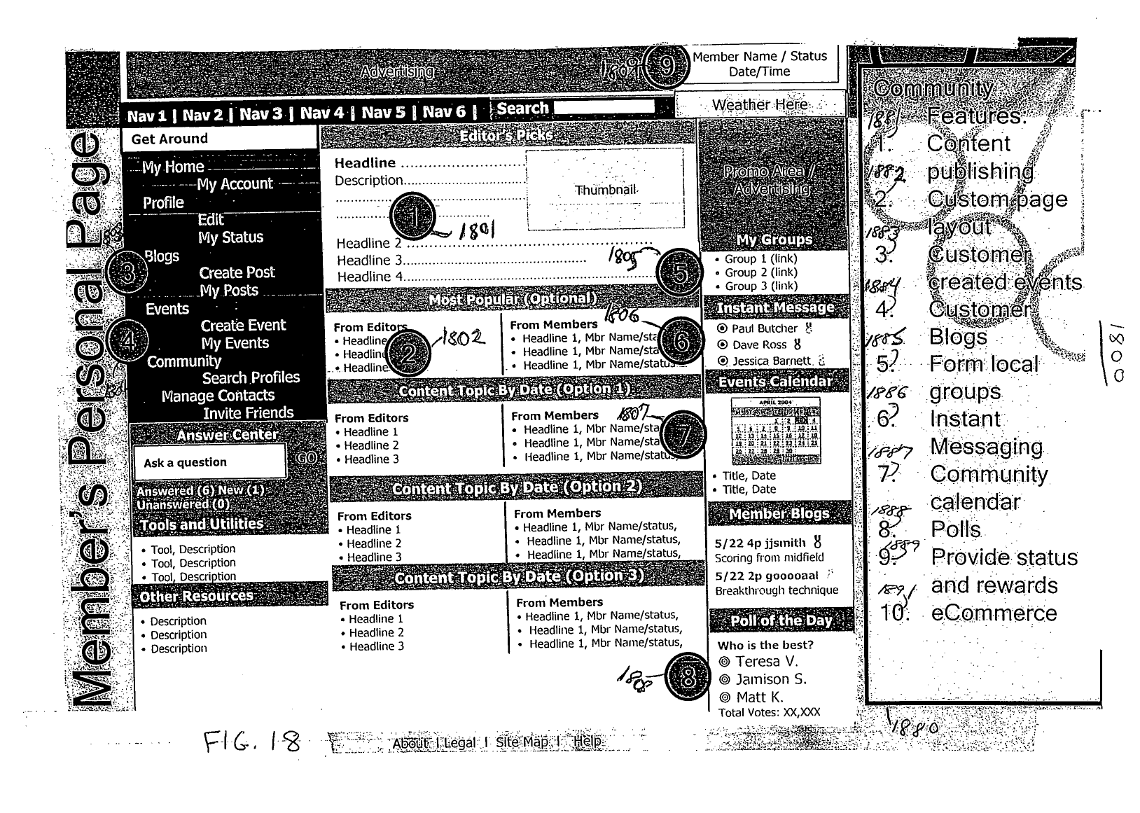

FIG. 18 shows illustrative graphical user interface (GUI) 1800. GUI 1800 may be implemented as one or more webpages for enrolled members. GUI 1800 may include several user-navigable feature areas. These areas may be organized as different frames within a single webpage, for example. Alternatively, each feature area may be organized as its own webpage linked to a main “homepage.” The user-navigable feature areas may include editor's picks area 1801, most popular articles area 1802, blogs area 1803, events area 1804, my groups area 1805, instant messaging (IM) area 1806, events calendar area 1807, and poll of the day area 1808. GUI 1800 may also include the name of the member, the member's current status, and the current date and/or time in status area 1809. Quick link box 1880 may include one-click access to the most common community features through a series of links (e.g., hyperlinks), such as content publishing link 1881, custom page layout link 1882, customer created events link 1883, customer blogs link 1884, local groups link 1885, IM link 1886, community calendar link 1887, polls link 1888, status and rewards link 1889, and ecommerce link 1891. A member may select any of the aforementioned links to be presented with the selected feature area.

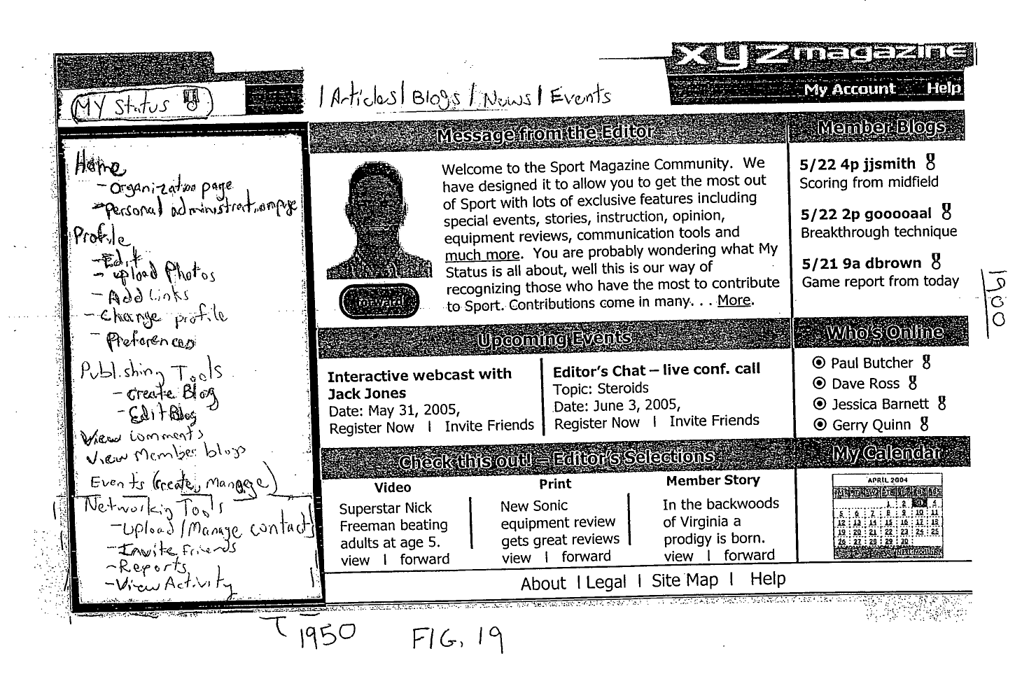

FIG. 19 shows illustrative graphical user interface 1900 for a typical member homepage. GUI 1900 may include some or all of the feature areas described in regard to FIG. 18. Member homepages may be customized by the member and allow for custom content delivery based on their categorized preferences and interests. From GUI 1900, a member may, for example, see what friends are currently online and logged into the community, view a community event calendar, access member blogs, edit the member's profile, or any other suitable action. A member may also access networking tool box 1950, which allows the member to upload or manage personal contacts, invite friends to the community, access reports, and view member participation activity.

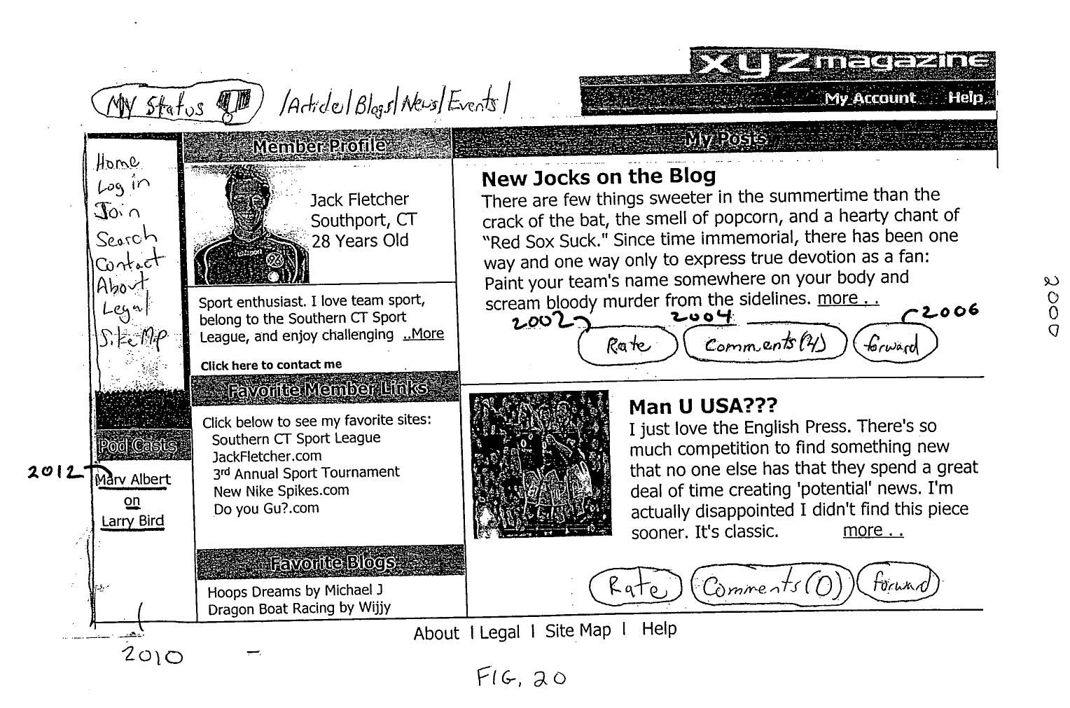

FIG. 20 shows graphical user interface 2000. A member may be presented with GUI 2000 after selecting customer blogs link 1884 (FIG. 18). GUI 2000 allows a member to browse member's blogs, search for specific content within member blogs, and perform related blog functions. A member may rate an individual blog (or a posting within a blog) by selecting rate button 2002. A member may post comments to the blog (if permitted) by pressing comments button 2004. A member may forward a posting within a blog to other members and potential members by selecting forward button 2006. GUI 2000 also allows a user to subscribe to or download one or more Pod Casts displayed in Pod Cast window 2010. For example, after a user clicks on Pod Cast 2012, Apple's iTunes software (or other suitable software) may automatically launch and bring the user to the Pod Cast homepage. The user may then subscribe to the Pod Cast on a regular basis or download the Pod Cast for later playback using an Apple iPOD or other suitable device.

GUI 1800 (FIG. 18), GUI 1900 (FIG. 19), and GUI 2000 may be part of a comprehensive online community. The community may help marketers develop a one-to-one relationship with members through personalized communications based on profiling. Incentives in the form of assets may help members advocate on behalf of the community. Some of the tools members may have access to within the online community include a personal profiles page, which allows members to create detailed personal profiles including text, images, and links to favorite websites, blogs, and other interests. Members of the online community may also have access to a group profiles page, where members can create detailed group profiles including text, images, and links to favorite websites, blogs, and other interests. Members may also communicate with their group, set up group events, and other related activities. Members may also integrate Really Simple Syndication (RSS) feeds into their homepages.

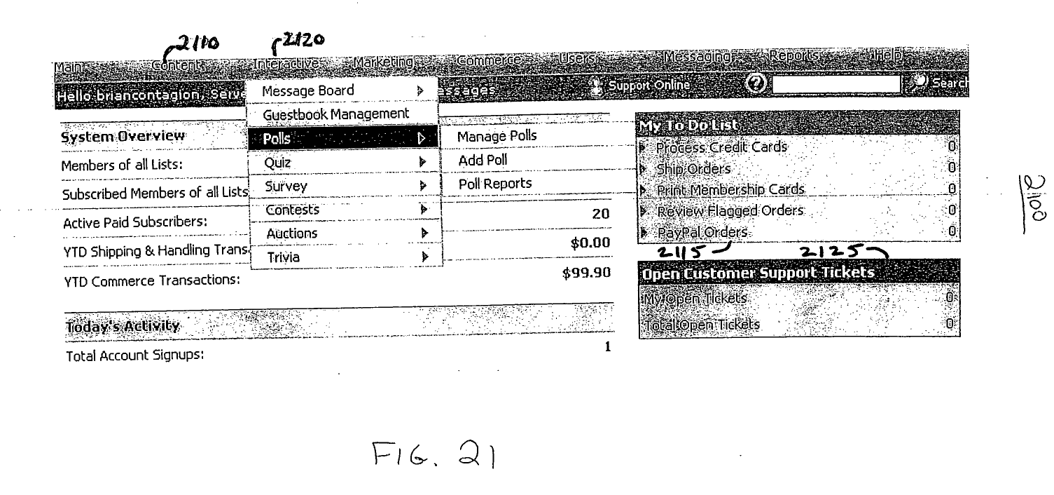

FIG. 21 shows graphical user interface 2100. GUI 2100 may be an administrative page for a particular community. For example, an authorized administrator may retrieve system statistics about the community, including the number of active paid subscribers, shipping and handling costs, and total commerce transactions. From menus 2110 and 2120, an administrator may add, remove, and manage content and interactive features (e.g., polls, surveys, contests, and auctions). Administrators may also be provided with a to do list in list area 2115 and a summary of open customer support tickets in support summary area 2125.

In any of the above embodiments, members may earn points for any number of activities (e.g., successful referrals, views, and contributing content). Such points, however, may or may not be utilized for redeeming rewards. For example, points may be awarded to a user in a manner that reflects the user's standing and activeness in the community. Accordingly, members that have a high value to the community may be treated differently than members that have a low value to the community.

For example, only those members that obtain a particular number of points, or maintain a particular number of points for particular periods of time, may be provided with the opportunity to begin a referral campaign for a friend. As per another example, a member's point total may reflect the type of content (e.g., web content) the member can access. As per yet another example, a member's point total may reflect the assets that are available to referred friends in referral communications. Such points may, however, be redeemable for any type of content or ability (e.g., the ability to generate referral email campaigns or access and/or create member blogs).

Persons skilled in the art will appreciate that a point system that is indicative of a user's activeness and benefit to the community may be utilized such that resources are focused on the most active and beneficial user's to the community. Thus, a marketing campaign may utilize such a point system to determine which users have the most vested interest in the community such that the system can only allow such users to send referral emails with highly desirable assets (e.g., a question and answer session with a celebrity that can only cater to a limited attendance). Such a system may also encourage underachieving members to earn the right to access content and other abilities.

Thus, once a user has gained status in the community by accumulating points (and being recognized as an active and beneficial user), the user may then be asked to initiate a referral campaign for one or more friends. The system may not, in some embodiments, provide the ability for email campaigns to be initiated until the user has gained a particular status (e.g., by accumulating a particular number of points). The email may then include a dynamic asset. A dynamic asset may be, for example, an asset from an asset database that can periodically be updated with new assets. Thus, for example, a dynamic asset in a referral email may call upon a particularly tagged asset. Yet, the asset attached to the tag may be changed by an administrator such that the referral email templates can remain the same yet yield different assets. The assets can also be dynamic, for example, by changing with respect to particular information. Thus, different assets may be provided to referred users that are men then to users that are women. Different assets may be provided to different categories of users (e.g., coaches, students, minors, adults, and seniors).

Persons skilled in the art will also appreciate that the present invention is not limited to only the embodiments described. Instead, the present invention more generally involves providing an online community of users. Persons skilled in the art will also appreciate that the structures described herein may be combined without departing from the principles of the present invention. All such modifications are within the scope of the present invention, which is limited only by the claims that follow.

What is claimed is:

1. A system comprising:
a user database, wherein said user database stores a member profile having a plurality of member profile fields, one of said member profile fields is a member name, and another one of said member profile fields is a prospective member email address;
a prospect database, wherein said prospect database stores a prospect member profile associated to said prospective member email address, said prospective member profile having a plurality of prospective member fields;
an asset database, wherein said asset database stores a plurality of assets and said assets are categorized dynamically according to at least one of said prospective member fields; and
a referral email generator to generate and send a referral email to said prospective member email address, wherein said referral email is signed by an administrator and said member name, includes at least one of said plurality of assets based on the information from said prospective member profile, and provides the ability for said prospective member email address to join.

2. The system of claim 1 further comprising at least one email template for use by said referral email generator.

3. The system of claim 2 wherein said referral email generator is configured to merge at least one of said member profile fields with said email template.

4. The system of claim 2 wherein said at least one email template defines static information and dynamic information.

5. The system of claim 4 wherein said dynamic information comprises at least one of said plurality of assets.

6. The system of claim 4 wherein said dynamic information comprises a hyperlink to at least one of said plurality of assets.

7. The system of claim 1 wherein said plurality of assets are selected from the group consisting of online chats, software, digital music, and webcasts.

8. The system of claim 1 wherein the referral email generator is configured to automatically resend said referral email to said prospective member email address after a predetermined amount of time.

9. A system comprising:
a user database, wherein said user database stores a member profile having a plurality of member profile fields, one of said member profile fields is a member name, and another one of said member profile fields is a prospective member email address;
a prospect database, wherein said prospect database stores a prospect member profile associated to said prospective member email address, said prospective member profile having a plurality of prospective member fields;
an asset database, wherein said asset database stores a plurality of assets; and
a referral email generator to generate a referral email to said prospective member email address, wherein said referral email is signed by an administrator and said member name, includes at least one of said assets, includes an introductory section manually entered by a member associated with said member profile, and provides the ability for said prospective member email address to join.

10. The system of claim 9 further comprising at least one email template for use by said referral email generator.

11. The system of claim 10 wherein said referral email generator is configured to merge at least one of said member profile fields with said email template.

12. The system of claim 10 wherein said at least one email template defines static information and dynamic information.

13. The system of claim 12 wherein said dynamic information comprises at least one of said plurality of assets.

14. The system of claim 12 wherein said dynamic information comprises a hyperlink to at least one of said plurality of assets.

15. The system of claim 9 wherein said plurality of assets are selected from the group consisting of online chats, software, digital music, and webcasts.

16. The system of claim 9 wherein the referral email generator is configured to automatically resend said referral email to said prospective member email address after a predetermined amount of time.

17. A method comprising:
determining a benefit of a user to an online community;
prompting said user with the ability to initiate a referral campaign when said benefit exceeds a benefit threshold; and
generating a referral email as part of said referral campaign that is addressed to a prospective member email address manually inputted by said user, signed by an administrator and said user, and includes at least one dynamic asset.

18. The method of claim 17, wherein generating a referral email comprises autonomously generating said referral email using a referral email generator and an ability to edit said referral email is provided to said user after said referral email is generated but before said referral email is sent.

19. The method of claim 17, further comprising accepting user input from said user to initiate said referral campaign.

20. The method of claim 17, further comprising generating a second referral email after a pre-determined period of time.
